(19) United States
(12) Patent Application Publication
(10) Pub. No.: US 2013/0180954 A1
(43) Pub. Date: Jul. 18, 2013

(54) MULTI-ZONE DIRECT GAS FLOW CONTROL OF A SUBSTRATE PROCESSING CHAMBER

(71) Applicant: APPLIED MATERIALS, INC., Santa Clara, CA (US)

(72) Inventor: ALEXANDER DEGIS, Austin, TX (US)

(73) Assignee: APPLIED MATERIALS, INC., Santa Clara, CA (US)

(21) Appl. No.: 13/734,222

(22) Filed: Jan. 4, 2013

Related U.S. Application Data
(60) Provisional application No. 61/587,981, filed on Jan. 18, 2012.

(51) Int. Cl. F17D 1/02

(52) U.S. Cl. CPC F17D 1/02
USPC 216/67; 156/345.33; 156/345.29

(57) ABSTRACT

Methods and apparatus for processing a substrate are provided herein. In some embodiments, an apparatus for processing a substrate may include a plasma process chamber having a processing volume and a substrate support disposed in the processing volume, the substrate support having a substrate support surface for supporting a substrate; a plurality of first gas inlets to provide a process gas to the processing volume, wherein the plasma process chamber is configured such that flowing the process gas at the same flow rate from each first gas inlet produces a non-uniform plasma at the substrate support surface; and a plurality of flow controllers, wherein each flow controller of the plurality is coupled to a corresponding one of the plurality of first gas inlets to control the flow of the process gas from the corresponding one first gas inlet.

### CROSS-REFERENCE TO RELATED APPLICATIONS

This application claims benefit of U.S. provisional patent application Ser. No. 61/587,981, filed Jan. 18, 2012, which is herein incorporated by reference.

### FIELD

Embodiments of the present invention generally relate to methods for processing substrates.

### BACKGROUND

Substrate processing systems, such as plasma reactors, may be used to deposit, etch, or form layers on a substrate. Asymmetries in such systems may exist which cause the formation of an undesired plasma profile resulting in low quality substrate processing.

Thus, the inventor has provided herein embodiments of substrate processing systems that may provide improved substrate processing.

### SUMMARY

Methods and apparatus for processing a substrate are provided herein. In some embodiments, an apparatus for processing a substrate may include a plasma process chamber having a processing volume and a substrate support disposed in the processing volume, the substrate support having a substrate support surface for supporting a substrate; a plurality of first gas inlets to provide a process gas to the processing volume, wherein the plasma process chamber is configured such that flowing the process gas at the same flow rate from each first gas inlet produces a non-uniform plasma at the substrate support surface; and a plurality of flow controllers, wherein each flow controller of the plurality is coupled to a corresponding one of the plurality of first gas inlets to control the flow of the process gas from the corresponding one first gas inlet.

In some embodiments, an apparatus for processing a substrate may include: a plasma process chamber having a processing volume and a substrate support disposed in the processing volume, the substrate support having a substrate support surface to support a substrate; a plurality of first gas inlets to provide a process gas to the processing volume, wherein the plasma process chamber is configured such that flowing the process gas at the same flow rate from each first gas inlet produces a non-uniform plasma at the substrate support surface; a plurality of flow controllers, wherein each flow controller of the plurality is coupled to a corresponding one of the plurality of first gas inlets to control the flow of the process gas from the corresponding one first gas inlet; a plasma source to generate an electric field within the processing volume to form a plasma from the process gas; and a pumping channel to remove one or more gases from the processing volume, wherein the pumping channel is disposed asymmetrically with respect to the processing volume.

In some embodiments, a method of forming a plasma in a process chamber may include generating an electric field within a processing volume having a first region and a second region of the process chamber using a plasma source, wherein the first region and second region have different plasma forming environments; and injecting a process gas into the first region at a first flow rate and into the second region at a second flow rate different from the first flow rate to form a plasma in the processing volume.

Other and further embodiments of the present invention are described below.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a side schematic of an apparatus for processing a substrate in accordance with some embodiments of the present invention.

FIG. 2 depicts a top schematic of an apparatus for processing a substrate in accordance with some embodiments of the present invention.

FIG. 3 depicts a flow chart for a method of forming a plasma in a process chamber in accordance with some embodiments of the present invention.

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

Methods and apparatus for processing a substrate are disclosed herein. The inventive methods and apparatus may advantageously control the flow of process gas to form a plasma having a desired profile for processing a substrate. For example, control of the process gas flow may be utilized to overcome one or more asymmetries in the apparatus that cause an undesired plasma profile to be formed. Asymmetries may include an asymmetrically disposed pumping channel, asymmetric electric field, or the like which may require a substantial chamber re-design to correct. Accordingly, the present invention may further provide a cost effective solution to existing chamber asymmetries.

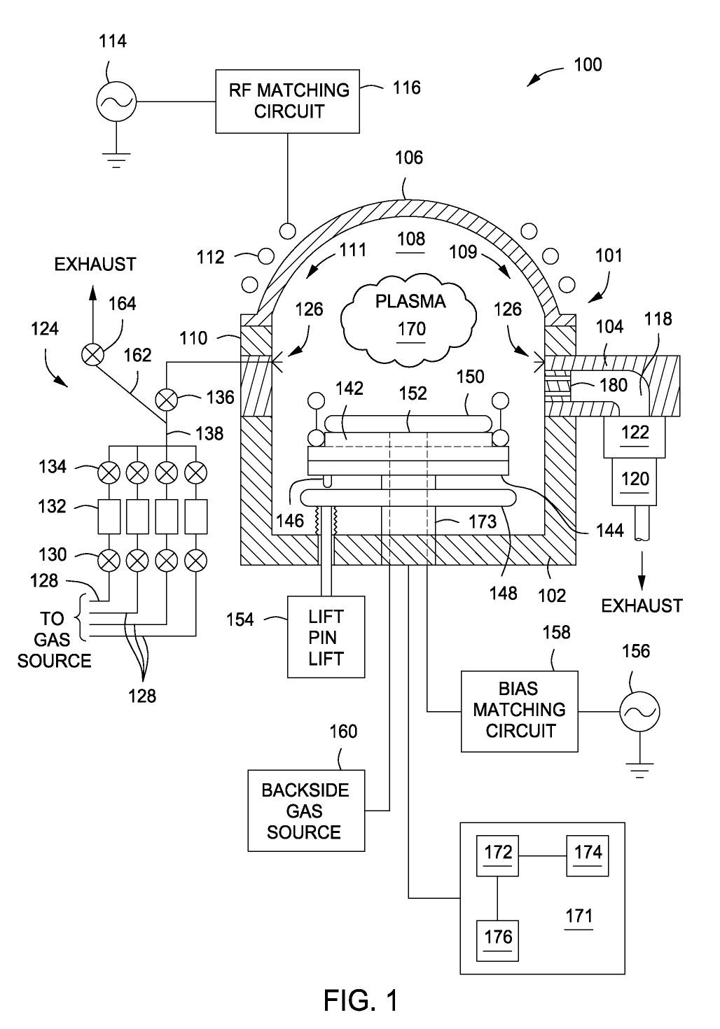

FIG. 1 depicts a side schematic view of an apparatus 100 in accordance with some embodiments of the present invention. For example, the apparatus 100 may be configured for etch, deposition, or any suitable plasma process. The apparatus 100 may include a plasma process chamber 101 having a lower chamber body 102, an upper chamber body 104, and a ceiling 106 which enclose a process volume 108. The ceiling 106 may be flat or have some other geometry. In some embodiments, the ceiling 106 is a dome. In some embodiments, an interchangeable spacer 110 may be provided between the ceiling 106 and the upper chamber body 104 so that the inclination and/or height of the ceiling 106 relative to the upper chamber body 104 may be selectively changed as desired.

An RF coil 112 may be disposed above the ceiling 106 and coupled to an RF source 114 through a matching circuit 116. The ceiling 106 is transmissive to the RF power such that source power applied to the coil 112 from the RF source 114 may be inductively coupled to gases disposed in the process volume 108 of the reactor 100, for example, to form and/or maintain a plasma 170. While the RF coil 112 may be symmetric with respect to a central axis of the process chamber (or a support surface of a substrate support disposed therein), for example, as illustrated in FIG. 1, asymmetry in the electric field produced by the coil 112 may still arise from other aspects of the chamber 101, such as other metallic components or the like that may distort the electric field. Power applied to the coil 112 may be referred to as source power.

The source power may be provided at a radio frequency within a range from about 2 MHz to about 60 MHz at a power within a range from about 10 watts to about 5000 watts. The source power may be pulsed or applied in a continuous wave.

The upper chamber body 104 may include a pumping channel 118 that connects the process volume 108 of the reactor 100 to a pump 120 through a throttle valve 122. In some embodiments, an exhaust screen 180 may be disposed within the upper chamber body 104 to further control the exhaust flow between the process volume 108 and the pumping channel 118. The pumping channel 118 may remove one or more gases from the processing volume 108. As illustrated in FIG. 1, the pumping channel 118 may be asymmetrically disposed with respect to the processing volume 108. The asymmetry of the pumping channel 108 may result in varied pressure in regions of the processing volume 108 during operation, for example, such as a first region 109 adjacent the pumping channel 108 and a second region 111 opposing the pumping channel 108. In some embodiments, a first pressure in the first region 109 may be greater than a second pressure in the second region 111 due to the operation of the pump 120. The pump 120 and throttle valve 122 may be operated to control the pressure within the process volume 108 of the reactor 100. The pump 120 also removes process by-products. A baffle plate 180 may be disposed in the pumping channel 118 to minimize contamination of the pump 120 and to improve conductance within the process volume 108.

The apparatus 100 may include a fast gas exchange system 124 coupled thereto that provides process and/or other gases to the process volume 108 through a plurality of first gas inlets 126 positioned around the interior of the upper chamber body 104 or other suitable location.

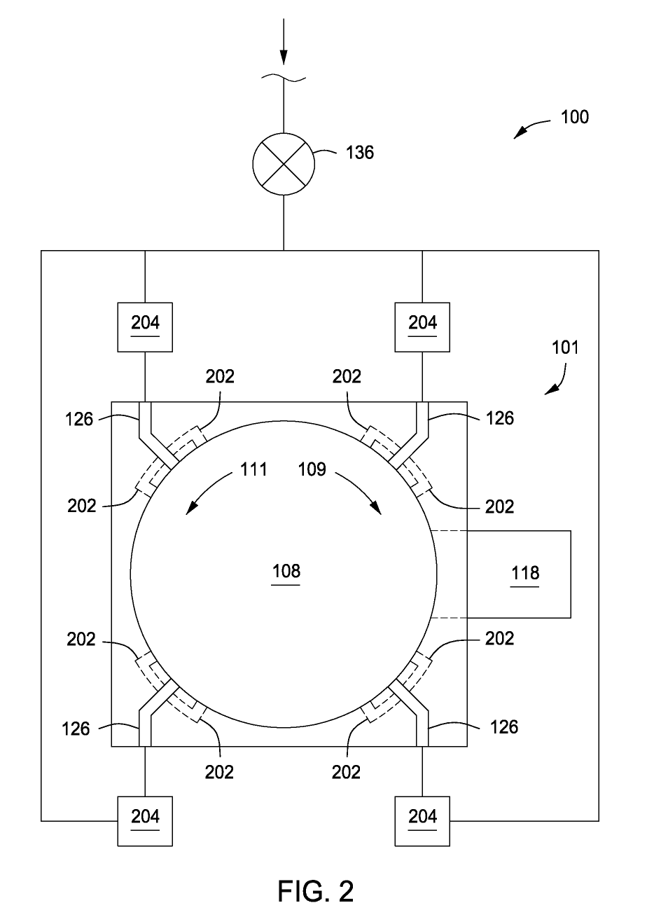

FIG. 2 depicts a top schematic view of the apparatus 100 in accordance with some embodiments of the present invention. As illustrated in FIG. 2, the plurality of first gas inlets 126 may be symmetrically, or equidistantly, spaced about the processing volume 108. In some embodiments, and as shown, the number of first gas inlets 126 in the plurality of first gas inlets 126 is four. However, additional or fewer first gas inlets 126 may be provided. In some embodiments, two of the plurality of first gas inlets 126 disposed adjacent to either side of the pumping channel 118 are disposed equidistantly from pumping channel 118, as illustrated in FIG. 2 (showing two first gas inlets 126 disposed in the first region 109 of the processing volume 108). The configuration of first gas inlets 126 illustrated in FIG. 2 is merely exemplary and other configurations may be possible, such as a first gas inlet disposed directly above the pumping channel 118 or any suitable configuration capable of producing the desired flow of process gas to yield a plasma having a desired profile.

In some embodiments, the apparatus 100 may further comprises a plurality of second gas inlets 202. As illustrated in FIG. 2, and in some embodiments more than one second gas inlet 202 may be coupled to a corresponding one of the plurality of first gas inlets 126 to provide the process gas to the processing volume 108. For example, the second gas inlets 202 may be utilized to further distribute the process gas in a desired distribution to the processing volume. Although illustrated in FIG. 2, as two second gas inlets 202 to each first gas inlet 126, other configurations may be possible, such as more or less than two second gas inlets 202 to each first gas inlet 126. Further, although illustrated in FIG. 2 as a symmetric configuration of first and second gas inlets, wherein each first gas inlet 126 has two second gas inlets 202 coupled thereto, non-symmetric configurations may be possible, such one or more of the first gas inlets 126 being coupled to a different number of second gas inlets 202 or no second gas inlets at all.

The apparatus 100 may include a plurality of flow controllers 204, wherein each one flow controller of the plurality is coupled to a corresponding one of the plurality of first gas inlets 126 to control the flow of the process gas provided to the process chamber via the respective first gas inlet 126. For example, the plurality of flow controllers 204 may be disposed between the fast gas exchange system 124 and the plurality of first gas inlets 126, such that a flow of a process gas provided by the system 124 may be individually controlled at each corresponding first gas inlet 126.

Returning to FIG. 1, the fast gas exchange system 124 selectively allows any singular gas or combination of gases to be provided to the process volume 108. In some embodiments, the fast gas exchange system 124 has four delivery lines 128, each coupled to a different gas source. Each delivery line 128 includes a first valve 130, a mass flow meter 132, and a second valve 134. The second valves 134 are coupled to a common tee 138, which is coupled to the first gas inlets 126. The conduits through which gases flow from mass flow meters 132 to the process volume 108 is less than about 2.5 m in length, thereby allowing faster switching times between gases. The fast gas exchange system 124 may be isolated from the process volume 108 of the reactor 100 by an isolation valve 136 disposed between the tee 138 and first gas inlets 126.

An exhaust conduit 162 is coupled between the isolation valve 136 and the tee 138 to allow residual gases to be purged from the fast gas exchange system 124 without entering the reactor 100. A shut off valve 164 is provided to close the exhaust conduit 162 when gases are delivered to the process volume 108 of the reactor 100.

The gas sources coupled to the fast gas exchange system 124 may provide gases suitable for the desired process to be performed. For example, in an exemplary etch process, the gases provided may include, but are not limited to, sulfur hexafluoride (SF₆), oxygen (O₂), argon (Ar), trifluoromethane (CHF₃), octafluorocyclobutane (C₄F₈), nitrogen trifluoride (NF₃), carbon tetrafluoride (CF₄), trifluoromethane (CHF₃), chlorine trifluoride (ClF₃), bromine trifluoride (BrF₃), iodine trifluoride (IF₃), helium-oxygen gas (HeO₂), helium-hydrogen gas (HeH₂), hydrogen (H₂), helium (He), and/or other gases for use in the processes as described herein. The flow control valves may include pneumatic operation to allow rapid response. In one example, the fast gas exchange system 124 is operable to deliver SF₆ and C₄F₈ at up to about 1000 sccm, helium at about 500 sccm, and oxygen (O₂) and argon at about 200 sccm. In an alternative embodiment, the fast gas exchange system 124 may further include a third gas panel comprising of a plasma sustaining gas, such as argon and/or helium, and may be operable to continuously deliver the gas to the reactor 100 during a cyclical etching method, as described further below.

The chamber 101 additionally includes a substrate support 152 disposed in the process volume 108. The substrate support 152 may include an electrostatic chuck 142 mounted on a thermal isolator 144. The thermal isolator 144 insulates the electrostatic chuck 142 from a stem 173 that supports the electrostatic chuck 142 above the bottom of the lower chamber body 102.

Lift pins 146 may be disposed through the substrate support 152. A lift plate 148 is disposed below the substrate support 152 and may be actuated by a lift 154 to selectively displace the lift pins 146 to lift and/or place a substrate 150 on an upper surface of the electrostatic chuck 142.

The electrostatic chuck 142 includes at least one electrode (not shown) which may be energized to electrostatically retain the substrate 150 to the upper surface of the electrostatic chuck 142. An electrode of the electrostatic chuck 142 may be coupled to a bias power source 156 through a matching circuit 158. The bias power source 156 may selectively energize the electrode of the electrostatic chuck 142 to control the directionality of the ions during etching.

The bias power applied to the electrostatic chuck 142 by the bias power source 156 may be pulsed, e.g. repeatedly storing or collecting the energy over a time period and then rapidly releasing the energy over another time period to deliver an increased instantaneous amount of power, while the source power may be continuously applied.

In some embodiments, a backside gas source 160 may be coupled through the substrate support 152 to provide one or more gases to a space (not shown) defined between the substrate 150 and the upper surface (e.g., a substrate support surface) of the electrostatic chuck 142. Gases provided by the backside gas source 160 may include helium and/or a backside process gas. The backside process gas is a gas delivered from between the substrate and the substrate support which, for example, may affect the rate of etch or polymerization during an etch cycle by reacting with the materials in the chamber, such as process gases, etch by-products, mask or other layers disposed on the substrate or the material targeted for etching. In some embodiments, the backside process gas may be an oxygen containing gas, such as O₂. In some embodiments, a ratio of He to O₂ in the backside gas may be about 50:50 to about 70:30 by volume or by mass for silicon etch applications. It is contemplated that other backside process gases may be utilized to control the processes near the edge of the substrate. The use of backside process gases may be used beneficially for single step etch processes as well as cyclical etch processes.

To enable the process gas provided by the backside gas source 160 to reach the edge of the substrate 150, the rate of backside gas leakage from under the edge of the substrate 150 is higher than that of conventional backside gas systems. In some embodiments, the leak rate may be elevated by maintaining the pressure of the gases in the space (not shown) between the substrate 150 and the upper surface of the electrostatic chuck 142 between about 4 and 26 Torr. In some embodiments, the pressure may be maintained between about 10 and 22 Torr. In some embodiments, the pressure may be maintained between about 14 and 20 Torr. The leak rate may also be achieved by providing notches (not shown) or other features in a lip (not shown) supporting the substrate 150 and the upper surface of the electrostatic chuck 142 which promotes leakage of the backside gas between the electrostatic chuck 142 and the substrate 150.

The apparatus 100 may further include a controller 171 which generally comprises a central processing unit (CPU) 172, a memory 174, and support circuits 176 and is coupled to and controls the etch reactor 100 and various system components, such as the RF source 114, fast gas exchange system 124 and the like, directly (as shown in FIG. 1) or, alternatively, via other computers or controllers (not shown) associated with the process chamber and/or the support systems. The controller 171 may be one of any form of general-purpose computer processor that can be used in an industrial setting for controlling various chambers and sub-processors. The memory, or computer-readable medium, 174 of the CPU 172 may be one or more of readily available memory such as random access memory (RAM), read only memory (ROM), floppy disk, hard disk, or any other form of digital storage, local or remote. The support circuits 176 are coupled to the CPU 172 for supporting the processor in a conventional manner. These circuits include cache, power supplies, clock circuits, input/output circuitry and subsystems, and the like. Inventive methods as described herein (such as the method 300 described below) may be stored in the memory as software routine. The software routine, when executed by the CPU 172, transforms the general purpose computer into a specific purpose computer (controller) 178 that controls the operation of the reactor 100 in the manner described herein. The software routine may also be stored and/or executed by a second CPU (not shown) that is remotely located from the hardware being controlled by the CPU 172 of the controller 174.

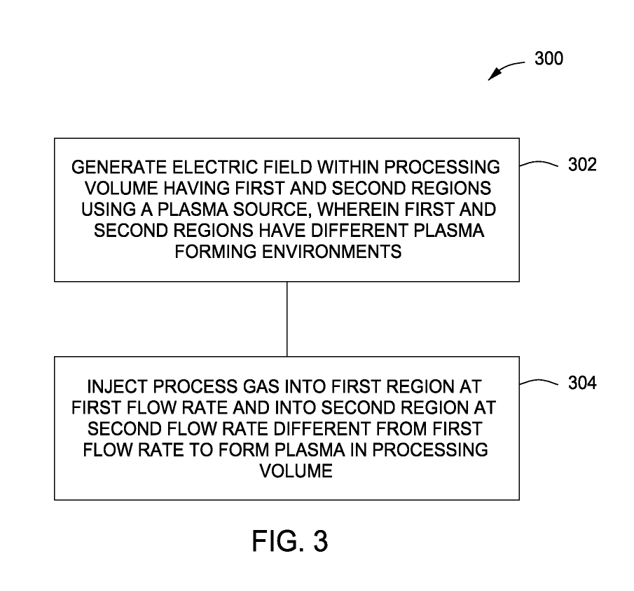

FIG. 3 depicts a flow chart for a method 300 for forming a plasma (for example, to process a substrate) in accordance with some embodiments of the present invention. The method 300 may be practiced in the apparatus 100, or other suitable plasma process chambers. The method 300 is described below in accordance with the apparatus 100 as depicted in FIGS. 1-2.

The method 300 begins at 302 by generating an electric field within the processing volume 108 having the first region 109 and the second region 111 of the process chamber 108 using the plasma source 114, wherein the first region 109 and second region 111 have different plasma forming environments. As used herein, the phrase “different plasma forming environments” does not refer to merely different regions of the process chamber, but instead refers to, for example, different environments due to asymmetries caused by the asymmetric disposed pumping channel 118 or asymmetry in the electric field generated by the RF coil 112, that may affect the characteristics of the plasma formed in each different environment.

For example, the electric field may be asymmetric such that a property of the electric field in the first region 109 of the processing volume is different from the property of the electric field in the second region 111 of the processing volume. Exemplary electric field asymmetries may include an asymmetry in the shape of the electric field, the magnitude of the electric field, the density of the electric field, or the like.

For example, the processing volume 108 may be asymmetrically pumped by the pumping channel 118 such that a first pressure in the first region 109 of the processing volume 108 adjacent to the pumping channel 118 is greater than a second pressure in the second region 111 of the processing volume 108 opposing the pumping channel 118.

At 304, a process gas may be injected into the first region 109 at a first flow rate and into the second region 111 at a second flow rate different from the first flow rate to form a plasma (e.g., plasma 170) in the processing volume 108. For example, the first and second flow rates may be selected to overcome any asymmetries in the chamber 101, such as an asymmetric flow profile caused by the location of the pumping channel 118 with respect to the processing volume 108, or asymmetries in the electric field produced by the coil 112. The first and second flow rates may be selected to produce a flow profile of the process gas that results in a plasma having a desired profile for processing a substrate disposed on the substrate support 152.

In some embodiments, the second flow rate may be greater than the first flow rate. For example, the first flow rate may be the flow rate provided at each of the first and optionally second gas inlets 126, 202 disposed in the first region 109. Alternatively, the first flow rate may be the average flow rate provided at each of the first and optionally second gas inlets 126, 202 disposed in the first region 109. Similarly, the second flow rate may be provided at each of the first and optionally second gas inlets 126, 202 disposed in the second region 111, or alternatively, the second flow rate may be an average flow rate.

Further, the first and second regions 109, 111 are merely exemplary. The first and second regions 109, 111 may be defined in any desirable manner, such as equivalent halves as illustrated in FIGS. 1-2 or other non-equivalent configurations. Further, the method 300 is not limited to only first and second regions, such as the first and second regions 109, 111 defined above. For example, there may be any desired number of regions defined and they may include any desired number of first and second gas inlets 126, 202 and each region may be individually controlled to provide the desired process gas flow rate to form a plasma having a desire profile for processing a substrate disposed on the substrate support 152.

While the foregoing is directed to embodiments of the invention, other and further embodiments of the invention may be devised without departing from the basic scope thereof.

What is claimed is:

1. An apparatus for processing a substrate, comprising:
a plasma process chamber having a processing volume and a substrate support disposed in the processing volume, the substrate support having a substrate support surface to support a substrate;
a plurality of first gas inlets to provide a process gas to the processing volume, wherein the plasma process chamber is configured such that flowing the process gas at the same flow rate from each first gas inlet produces a non-uniform plasma at the substrate support surface; and
a plurality of flow controllers, wherein each flow controller of the plurality is coupled to a corresponding one of the plurality of first gas inlets to control the flow of the process gas from the corresponding one first gas inlet.

2. The apparatus of claim 1, further comprising:
a plurality of second gas inlets, wherein more than one second gas inlet is coupled to a corresponding one of the plurality of first gas inlets to provide the process gas to the processing volume.

3. The apparatus of claim 1, wherein the plurality of first gas inlets are equidistantly spaced about the processing volume.

4. The apparatus of claim 3, wherein the number of first gas inlets in the plurality of first gas inlets is four.

5. The apparatus of claim 1, further comprising:
a plasma source to generate an electric field within the processing volume to form a plasma from the process gas.

6. The apparatus of claim 5, wherein the plasma source further comprises:
an inductively coupled plasma source.

7. The apparatus of claim 6, wherein the inductively coupled plasma source further comprises:
one or more RF coils disposed externally to the processing volume.

8. The apparatus of claim 7, wherein the process chamber further comprises:
a domed ceiling, wherein the one or more RF coils are disposed about the domed ceiling.

9. The apparatus of claim 1, further comprising:
a pumping channel to remove one or more gases from the processing volume, wherein the pumping channel is disposed asymmetrically with respect to the processing volume.

10. The apparatus of claim 9, wherein the plurality of first gas inlets are equidistantly spaced about the processing volume, and wherein two of the plurality of first gas inlets disposed adjacent to the pumping channel are equidistantly spaced from the pumping channel.

11. An apparatus for processing a substrate, comprising:
a plasma process chamber having a processing volume and a substrate support disposed in the processing volume, the substrate support having a substrate support surface to support a substrate;
a plurality of first gas inlets to provide a process gas to the processing volume, wherein the plasma process chamber is configured such that flowing the process gas at the same flow rate from each first gas inlet produces a non-uniform plasma at the substrate support surface;
a plurality of flow controllers, wherein each flow controller of the plurality is coupled to a corresponding one of the plurality of first gas inlets to control the flow of the process gas from the corresponding one first gas inlet;
a plasma source to generate an electric field within the processing volume to form a plasma from the process gas; and
a pumping channel to remove one or more gases from the processing volume, wherein the pumping channel is disposed asymmetrically with respect to the processing volume.

12. The apparatus of claim 11, wherein the plasma source further comprises:
an inductively coupled plasma source; and
one or more RF coils disposed externally to the processing volume.

13. The apparatus of claim 11, further comprising:
a plurality of second gas inlets, wherein more than one second gas inlet is coupled to a corresponding one of the plurality of first gas inlets to provide the process gas to the processing volume.

14. The apparatus of claim 11, wherein the plurality of first gas inlets are equidistantly spaced about the processing volume, and wherein two of the plurality of first gas inlets disposed adjacent to the pumping channel are equidistantly spaced from the pumping channel.

15. The apparatus of claim 11, wherein the number of first gas inlets in the plurality of first gas inlets is four.

16. A method of forming a plasma in a process chamber, comprising:
generating an electric field within a processing volume having a first region and a second region of the process chamber using a plasma source, wherein the first region and second region have different plasma forming environments; and
injecting a process gas into the first region at a first flow rate and into the second region at a second flow rate different from the first flow rate to form a plasma in the processing volume.

17. The method of claim 16, wherein the second flow rate is greater than the first flow rate.

18. The method of claim 16, wherein the processing volume is asymmetrically pumped such that a first pressure in the first region of the processing volume adjacent to a pumping channel is greater than a second pressure in the second region of the processing volume opposing the pumping channel.

19. The method of claim 16, wherein the electric field is asymmetric such that a property of the electric field in the first region of the processing volume is different from the property of the electric field in the second region of the processing volume.

20. The method of claim 19, wherein the property of the electric field includes one or more of shape or density.
